(19) United States
(12) Patent Application Publication
(10) Pub. No.: US 2004/0205660 A1
(43) Pub. Date: Oct. 14, 2004

(54) System and method for generating and displaying attribute-enhanced documents

(76) Inventor: Joe Acton, Snoqualmie, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/132,109

(22) Filed: Apr. 23, 2002

(51) Int. Cl. G06F 17/24; G06F 17/21; G06F 17/00

(52) U.S. Cl. 715/530; 715/531

(57) ABSTRACT

A system, method, and computer-readable medium for generating and displaying attribute-enhanced documents. The present invention provides an attribute-enhanced document that reliably and continuously communicates contextual information that describes a property, characteristic, condition, or status associated with the document. In one embodiment, a system and method generate and display a document having one or more attributes that communicates contextual information with the contents of the document. The format of the attribute-enhanced document allows an interface to continuously and conspicuously display the contextual information with the document contents, even if the interface restricts the display of the document contents. Other embodiments allow the attribute-enhanced document to display a visual indicator or generate an audible signal to communicate a document's contextual information. The attribute-enhanced documents of the present invention allow users to identify a characteristic associated with the document in a rapid and easy manner.

### FIELD OF THE INVENTION

The present invention generally relates to computer software applications, and in particular, the present invention relates to computer software applications for generating and displaying documents having enhanced attributes.

### BACKGROUND OF THE INVENTION

In recent years, there has been a tremendous proliferation of computers connected to a global network known as the Internet. Consequently, a number of new developments in Internet-based software applications have greatly enhanced the availability of information to users worldwide. For example, many publishers and information service providers, such as VersusLaw® (www.versuslaw.com), Westlaw®, and LexisNexis® have developed customized document retrieval software applications for allowing users to review and retrieve legal documents from a wide range of resources. Such document retrieval software applications allow users to selectively review and retrieve a large quantity of desired documents by the use of a variety of known keyword- or index-based search techniques.

While existing document retrieval software applications provide a means for users to review and receive a voluminous quantity of documents, there are several disadvantages to existing systems. In particular, when a user reviews a particular document found in a search, existing systems make it difficult for the user to readily identify contextual information about a displayed document. For illustrative purposes, contextual information may include any information that describes a characteristic, status, condition, or property associated with the document or the subject matter described in the document. In addition, contextual information associated with the document may also include any information of possible interest to a user receiving or reviewing the document. In existing systems, users have some difficulty in identifying contextual information because some computer-generated graphical user interfaces only display small sections of text documents at one time. Thus, if a document is configured to display its contextual information in one section of the document, such as a header or footer, the contextual information cannot be viewed until the user scrolls to that particular section of the document. Even worse, some documents produced from existing retrieval software applications are not configured to display any contextual information to the user.

FIG. 1 illustrates one example of a graphical user interface 100 displaying a document 101, with the document's contextual information 108 configured in a header 110. In this illustrated example, the displayed document 101 is the result of a keyword search applied to a database storing a library of legal documents. Thus, the document may describe a legal subject and communicate contextual information associated with the document. For instance, the contextual information may indicate that the document is unpublished, withdrawn, etc. In a situation where the user is not familiar with the format of the document, the user may be required to spend valuable time locating the contextual information. In other situations, the user may not be able to identify the document's contextual information if it is abbreviated or if the user is conducting the search under a particular time limitation. As a result, the effort applied to a document search is greatly burdened if a user cannot readily locate the document's contextual information.

In existing systems, the difficulty of locating document contextual information is exacerbated by the fact that most retrieval software applications do not immediately display a document's contextual information when the document is first displayed. For instance, as shown in FIG. 2, when a search result is first displayed to a user, a document retrieval application may bypass the section showing the document's contextual information and immediately display a section of the document 101 containing the searched keyword (shown in bold text). As a result, a user viewing the document 101 may have to manually search through the document to locate and view the document's contextual information. This added burden decreases the chance that a user may view or even consider the contextual information during a search.

As shown in the examples of FIGS. 1 and 2, if the contextual information 108 of a document is not effectively communicated to a user, a document search may be significantly prolonged or, in some cases, the results of a document search may be flawed. As can be appreciated by those skilled in the legal industry, when a user does not fully consider contextual information that indicates an adverse status, e.g., an overruled or withdrawn opinion, such mistakes can lead to more serious consequences.

Accordingly, there exists a need for a system and method for generating and displaying attribute-enhanced documents that reliably provide document contextual information to a user, regardless of the section of the document that is displayed. In addition, there exists a need for integrating a system and method for generating and displaying attribute-enhanced documents in existing document retrieval software applications.

### SUMMARY OF THE INVENTION

The present invention addresses the above-identified needs by providing a system and method for generating and displaying attribute-enhanced documents. More specifically, the present invention provides a document format that effectively communicates contextual information that describes a property, characteristic, condition, or status associated with the document. The attribute-enhanced document allows a user interface to continuously and conspicuously display a document's contextual information with the contents of the document, even if the interface restricts the display of the document. For example, if a graphical user interface only shows one page of a multiple-page document, the attribute-enhanced document simultaneously displays at least one visual indicator that communicates contextual information about the document.

In accordance with one embodiment of the present invention, the visual indicator is displayed in a viewable portion of the graphical user interface along with the text of the document. The visual indicators may include images or text of contrasting color or shade, which serve to draw a user's attention. Through the use of the system and method provided herein, users may be able to view contextual information related to a document regardless of the section of the document that is displayed. The functionality provided by the present invention allows users to review and receive a large volume of documents in an efficient manner.

In one embodiment, a method of the present invention involves the generation of a document, wherein the method comprises receiving document data and contextual information related to the document data. The method also involves combining the document data with document format data for allowing the document to concurrently display the document data and the contextual information on a display device wherein the document is configured to continuously display the contextual information on the display device.

In another embodiment of the present invention, a method of displaying a document and contextual information associated with the document is provided. In this embodiment, the method comprises displaying at least one document in a first image group of a display. The method also involves displaying a visual indicator for communicating the contextual information on the display in a second image group concurrently with said first image group, wherein the visual indicator continuously displays the contextual information.

In accordance with one aspect of the present invention, the system and method for generating and displaying attribute-enhanced documents may be embodied in a networked computing environment. This embodiment comprises at least one server for processing and storing a plurality of attribute-enhanced documents and a client computer for receiving and displaying the attribute-enhanced documents.

In another embodiment of the present invention, the system and method for generating and displaying attribute-enhanced documents may be embodied in a single computing device. This embodiment comprises at least one computer for displaying the attribute-enhanced documents and a computer readable medium storing at least one attribute-enhanced document.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a screen diagram of a user interface, displaying one section of a document communicating the document's information;

FIG. 2 is a screen diagram of the user interface of FIG. 1, illustrating the display of another section of the document that does not communicate the document's contextual information;

FIG. 3 is a block diagram showing a plurality of computing devices connected to a network for generating and displaying attribute-enhanced documents, in accordance with the present invention;

FIG. 4 is a block diagram illustrating an architecture of a client computer utilized in accordance with the present invention;

FIG. 5 is a block diagram illustrating an architecture for a document server, in accordance with the present invention;

FIG. 6 is a block diagram illustrating an architecture for a process server, in accordance with the present invention;

FIGS. 7A-7B are screen diagrams of an illustrative Web page, displaying one embodiment of an attribute-enhanced document;

FIG. 8 is a screen diagram of an illustrative Web page, displaying another embodiment of an attribute-enhanced document utilizing multiple user interface sections;

FIG. 9 is a flow diagram illustrative of one embodiment of a routine for generating attribute-enhanced documents, in accordance with the present invention; and

FIG. 10 is a flow diagram illustrative of one embodiment of a routine for displaying an attribute-enhanced document in accordance with the present invention.

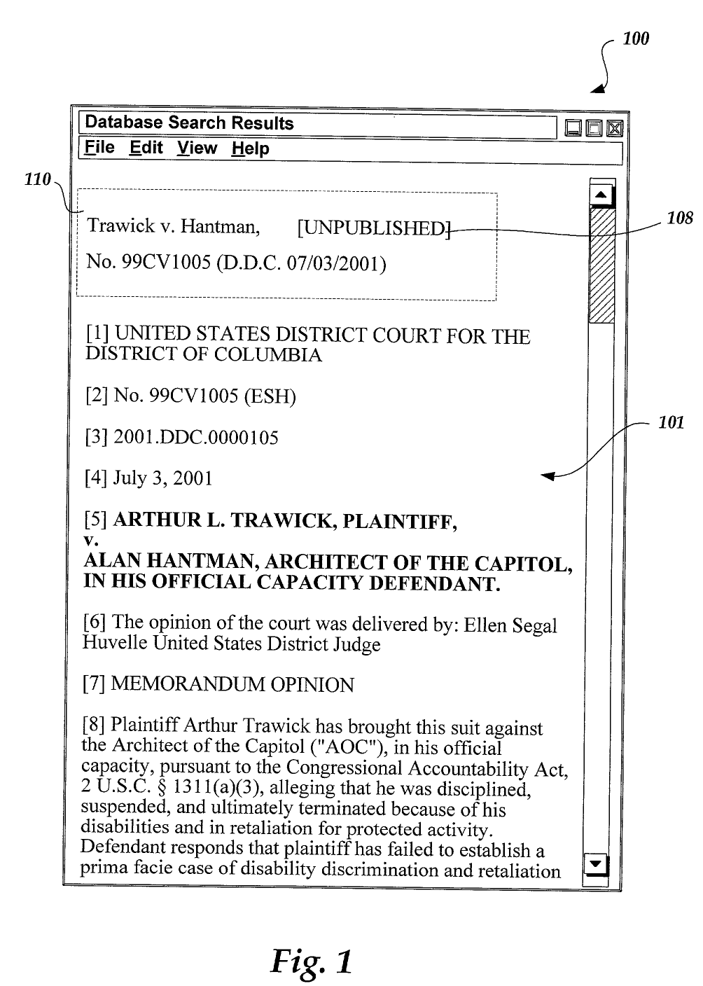

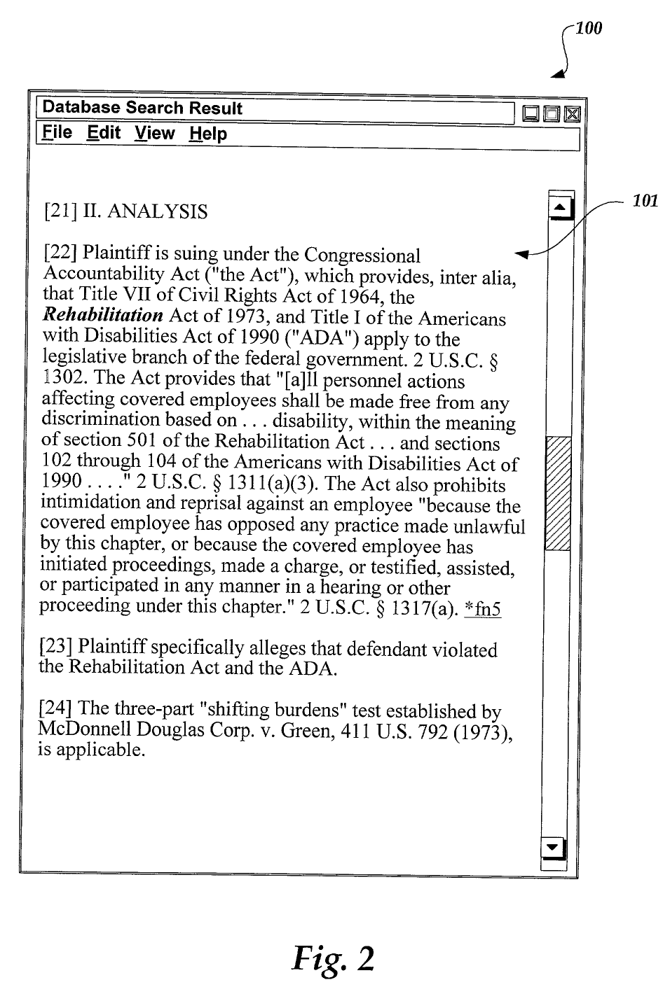

### DETAILED DESCRIPTION OF THE PREFERRED EMBODIMENT

The present invention is directed to a system and computer-implementable method for generating and displaying attribute-enhanced documents. As described in more detail below, along with the accompanying figures, the present invention provides a document format that effectively communicates contextual information that describes a property, characteristic, condition, or status associated with the document. The attribute-enhanced document allows a user interface to continuously and conspicuously display a document's contextual information with the contents of the document, even if the interface restricts the display of the document.

The following summary of the present invention first provides an overview of one suitable computing environment in which the invention may be implemented. The summary then provides a general description of a graphical user interface used in the operation of the system and method of the present invention. Lastly, the following summary provides an overview of two methods of generating and displaying attribute-enhanced documents.

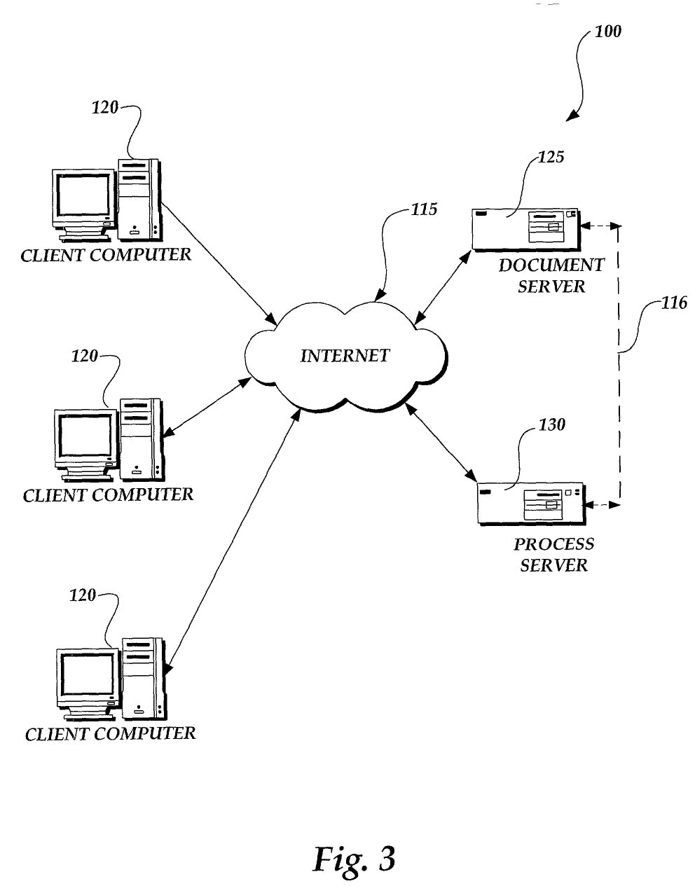

Referring to FIG. 3, the following discussion is intended to provide an exemplary overview of one suitable computing environment in which the invention may be implemented. Generally described, the computing environment may comprise a plurality of client computers 120, a document server 125, and a process server 130. Each computing device depicted in FIG. 3 is configured to electronically communicate via a network, such as the Internet 115. In addition, the document server 125 and process server 130 may be controlled by one business entity and, thus, also configured to electronically communicate via a local area network (LAN) 116. Alternatively, the document and process servers 125 and 130 may be constructed from one computing device or a plurality of computing devices, as needed for the appropriate application. As can be appreciated by one of ordinary skill in the art, the embodiments of the computing devices described herein are for illustrative purposes; therefore, any system capable of processing the methods described herein fall within the scope of the present invention.

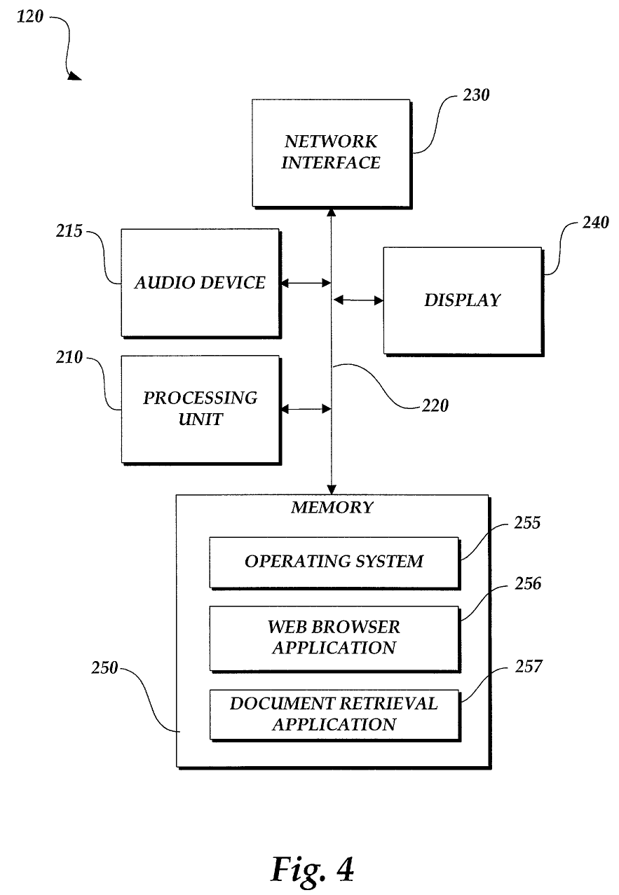

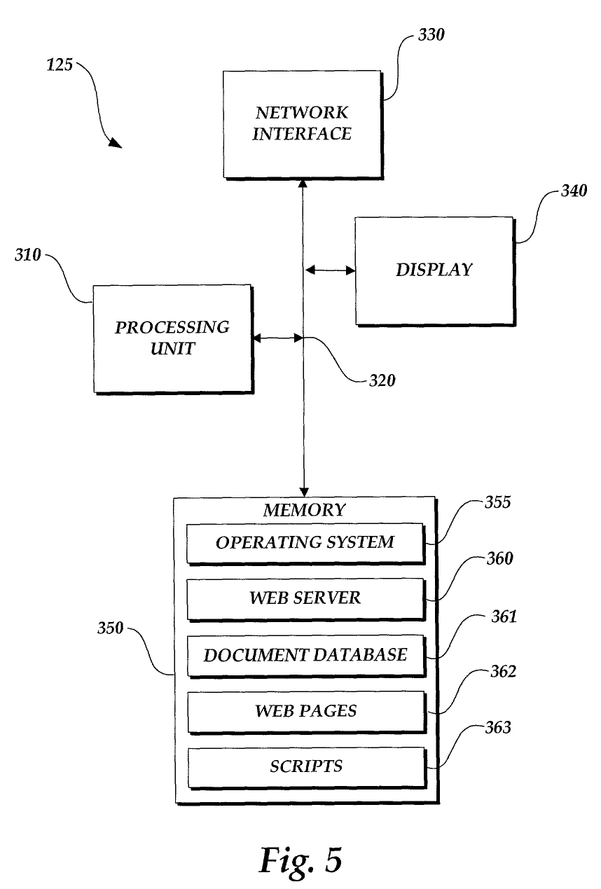

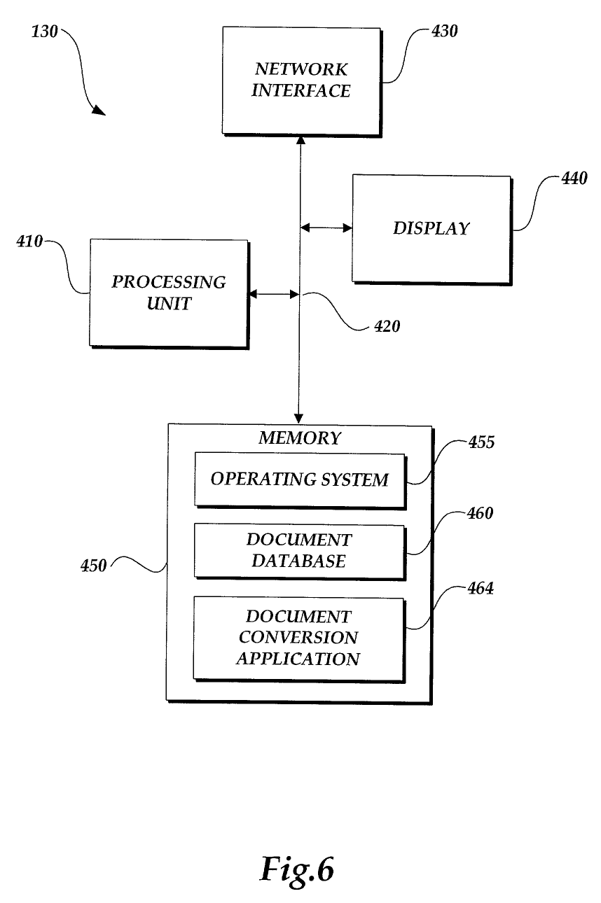

In the illustrated example described herein, the client computers 120 are used by an individual or entity for retrieving and displaying the documents stored in the document server 125. The client computers 120 are described in greater detail below, with respect to FIG. 4. The document server 125 contains a document retrieval software application for retrieving attribute-enhanced documents stored in a database. The document server 125 is described in greater detail below, with respect to FIG. 5. The process server 130 is utilized in one embodiment of the present invention for generating attribute-enhanced documents. The process server 130 is described in greater detail below. with respect to FIG. 6. It should be appreciated that the illustrative embodiment shown in FIG. 3 is one suitable computing environment for the present invention and that the methods described below may be implemented in any computing environment. For instance, the computing environment of FIG. 3 may be configured on an Intranet, thereby limiting the computing devices to a closed system.

As known to one of ordinary skill in the art, the term “Internet” refers to a collection of networks and routers that use the Internet protocol (IP) to communicate with one another. As known to one having ordinary skill in the art, the Internet 115 generally comprises a plurality of LANs and wide-area networks (WANs) that are interconnected by routers. Routers are special purpose computers used to interface one LAN or WAN to another. Communication links within the LANs may be twisted pair wire or coaxial cable, while communication links between the WANs may be optical links. As also known to one having ordinary skill in the art, the Web is a vast collection of generally interconnected hypertext documents electronically stored on server computers connected to the Internet 115.

Referring now to FIG. 4, an illustrative computer architecture for implementing a client computer 120 in accordance with one aspect of the present invention will be described. Those of ordinary skill in the art will appreciate that the client computer 120 may include many more components than those shown in FIG. 4. However, it is not necessary that all of these generally conventional components be shown in order to disclose an illustrative embodiment for practicing the present invention. As shown in FIG. 4, the client computer 120 includes a network interface 230 for connecting to the Internet 115. Those of ordinary skill in the art will appreciate that the network interface 230 includes the necessary circuitry for such a connection and is also constructed for use with the TCP/IP protocol.

The client computer 120 also includes a processing unit 210, an audio device 215, a display 240, and a memory 250. The memory 250 generally comprises a random access memory (RAM), a read-only memory (ROM), and a permanent mass storage device, such as a disk drive. The memory 250 stores the program code necessary for operating the client computer 120 and for providing a user interface on the display 240. In addition, the memory 250 stores a Web browser application 256, such as NETSCAPE NAVIGATOR® or MICROSOFT INTERNET EXPLORER®. The Web browser application 256 is utilized by a user of the client computer 120 to access information available on a server, such as the document server 125, via the Internet 115.

The client computer 120 may also comprise a document retrieval software application 257 for sending database queries to a server and displaying documents received from the server as a result of the database query. It will be appreciated that these software components may be loaded from a computer-readable medium into memory 250 of the client computer 120 using a drive mechanism associated with the computer-readable medium, such as a floppy, tape, or CD-ROM drive (not shown), or via the network interface 230.

Although an illustrative client computer 120 has been described that generally conforms to a conventional general purpose computing device, those of ordinary skill in the art will appreciate that the client computer 120 may comprise any number of devices capable of communicating with a network, such as the Internet 115, or with a server, such as the document server 125. For example, the client computer 120 may comprise a personal computer, two-way pager, mobile phone, personal data assistance (PDA), or the like.

Referring now to FIG. 5, a document server 125 utilized in an actual embodiment of the present invention will be described. In one embodiment of the present invention, the document server 125 may be associated with a business entity such as a publisher or any other service provider offering document search and/or delivery services. Those of ordinary skill in the art will appreciate that the document server 125 includes many more components than those shown in FIG. 5. However, it is not necessary that all of these generally conventional components be shown in order to disclose an illustrative embodiment for practicing the present invention. As shown in FIG. 5, the document server 125 comprises a network interface 330 that is used to electronically communicate with a network, such as the Internet 115. Those of ordinary skill in the art will appreciate that the network interface 330 includes the necessary circuitry for connecting the process server 130 to the Internet 115 and is constructed for the use with a communication protocol such as TCP/IP.

The document server 125 also includes a processing unit 310, a display 340, and a mass memory 350, all interconnected along within the network interface 330 via a bus 320. The mass memory 350 generally comprises RAM, ROM, and a mass storage device, such as a hard disk drive. The mass memory 350 stores the program code and data necessary for providing document search and delivery services, such as those services provided by VersusLaw® at the Web address, WWW.VERSUSLAW.COM. To provide such functionality, the mass memory 350 may store a document database 361 for storing attribute-enhanced documents. In addition, the mass memory 350 also comprises an operating system 355 configured to operate and control the functionality of the document server 125, such as Windows NT® from Microsoft Corporation. The mass memory 350 also stores a Web server application 360 for serving up the documents stored in the document database 361 and Web pages 362, which comprise the front pages of the Web site. The Web server application 360 may also include scripts 363 or other supporting program code for processing the stored documents. It will be appreciated that the aforementioned software components may be loaded from a computer-readable medium into the mass memory 350 of the process server 130 using a drive mechanism associated with the computer-readable medium, such as a floppy, tape, or CD-ROM drive (not shown), or via the network interface 330.

Referring now to FIG. 6, a process server 130 utilized in an actual embodiment of the present invention will be described. Generally described, the process server 130 may be utilized to generate attribute-enhanced documents that are made available to users via the document server 125. In such an embodiment, the process server 130 may receive document data from a number of resources and combine the received document data with other format data to produce a number of attribute-enhanced documents. Although this actual embodiment of the present invention involves a computer system utilizing two servers 125 and 130, any other system configuration capable of executing the methods described herein also falls within the scope of the present invention.

As shown in FIG. 6, the architecture of the process server 130 is similar to the architecture of the document server 125. For instance, the process server 130 comprises a network interface 430 for communicating document data with other computing devices. The process server 130 also comprises a processing unit 410, a display 440, and a mass memory 450, all interconnected, along within the network interface 430, via a bus 420. The mass memory 450 generally comprises RAM, ROM, and a mass storage device, such as a hard disk drive. The mass memory 450 stores the program code and data necessary for a number of document-related tasks, such as document formatting, generation, and data collection. To provide such functionality, the mass memory 450 may store a document database 460 for storing large volumes of documents and other related data. In addition, the mass memory 450 may also store an operating system 455 configured to operate and control the functionality of the process server 130 and other document conversion applications 464 for manipulating the format of document files. Similar to the computing devices described above, the aforementioned software components may be loaded by the use of any known computer-readable medium.

As described in detail below, the system and method generate a formatted document having one or more attributes that communicate contextual information associated with the document. The attribute-enhanced document allows a user interface to continuously and conspicuously display a document's contextual information with the contents of the document, even if the display of the document contents is restricted. In one embodiment, the attribute-enhanced document may communicate the document's contextual information by the use of a visual indicator. The visual indicator may include at least one shaded or colored graphical object or a number of text characters positioned throughout the document so that the document's contextual information is continuously displayed. In other embodiments of the present invention, a document's contextual information is communicated to a user by other methods, e.g., the generation of an audible signal or the like.

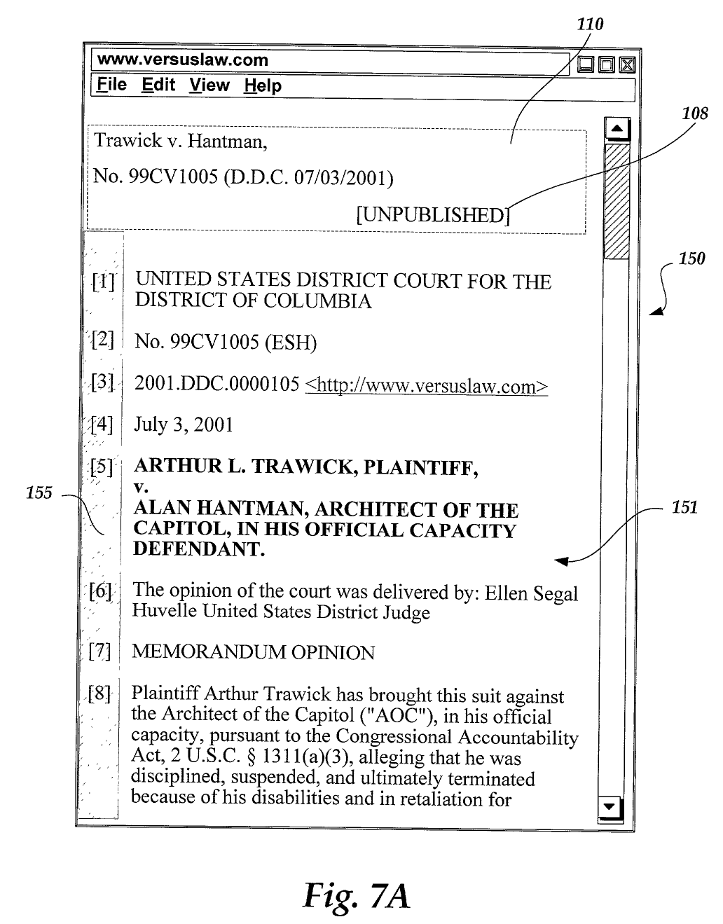

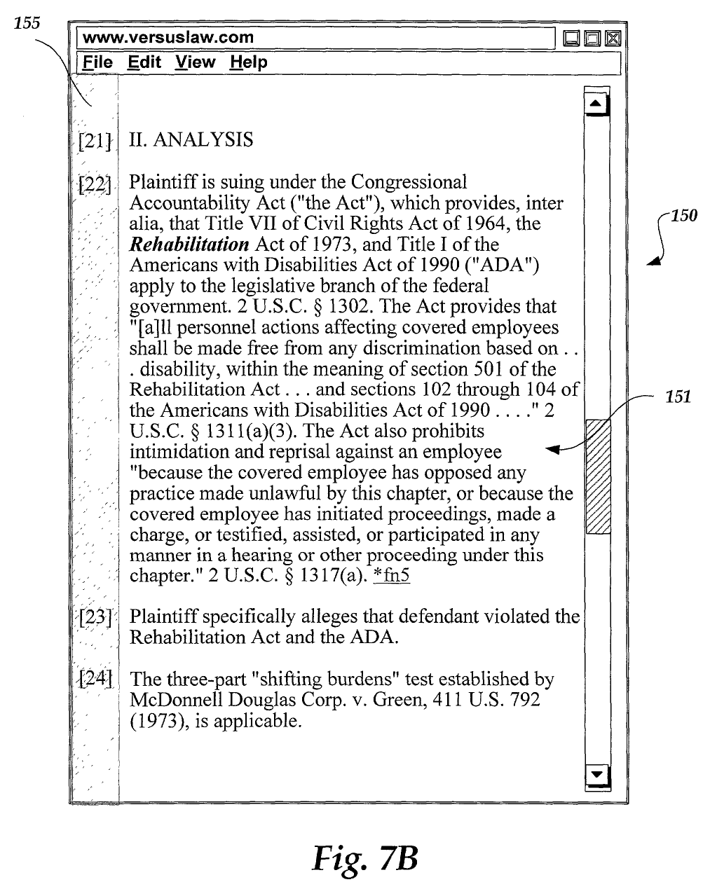

Referring now to FIG. 7A, aspects of an actual embodiment of the present invention will be described. The screen shot illustrated in FIG. 7A is one example of a user interface 150 configured to display an attribute-enhanced document 151 having a visual indicator 155. In this embodiment, the visual indicator 155 communicates the document's contextual information to the user. As shown in FIG. 7A, the attribute-enhanced document 151 may also include a header 110 with text describing contextual information associated with the contents of the document 151. In this example involving a legal document, the contextual information comprises status information 108 indicating that the document includes an “unpublished” legal opinion.

In accordance with one embodiment of the present invention, the displayed visual indicator 155 is configured with a color that communicates a particular status of the document. Optionally, a number of different colors or shades may be assigned to communicate other characteristics of the displayed document 151. For example, yellow may indicate that a document is unpublished; red may indicate that a document is withdrawn; green may indicate that the subject matter of the document involves a statute; and blue may indicate that the subject matter of the document involves a rule or regulation. In an embodiment involving color-coded visual indicators, the program displaying the document may include a description of the contextual information associated with each color in a pop-up window, help menu, or by the use of any other graphical interface. Although this illustrated example associates a particular color with a status of a legal document, the visual indicator can be any shape, shade, or image associated with any type of document or contextual information.

Also shown in FIG. 7A, this embodiment of the present invention involves a visual indicator 155 that is displayed along with the text of the document 151. In this embodiment, the visual indicator 155 is in the form of an image that extends through the length of the document, so that the visual indicator 155 is continuously displayed even if the interface 150 limits the display of the document 151. Thus, even if a user scrolls through the document 151, the interface 150 continuously displays the visual indicator 155.

Referring now to FIG. 7B, a representative section of the document 151 illustrated in FIG. 7A is shown and described. This illustration of the interface 150 further shows the configuration of the visual indicator 155. As shown, the visual indicator 155 is configured to be continuously displayed with the text of the attribute-enhanced document 151, so that the visual indicator 155 is conspicuously displayed even if the interface 150 only displays a limited section of the document 151. Also shown in this example, the visual indicator 155 still communicates the status of the document 151, even if the text version of the status information 108 is not currently displayed. Accordingly, if a document retrieval program immediately displays a limited section of the document 151 in response to a user's database query, the document's status is still effectively communicated to the user. As with other embodiments of the present invention, the visual indicator 155 is configured to continuously and conspicuously communicate document context information without interfering with the display of the contents of the document 151.

Although the illustrative embodiments disclosed in FIGS. 7A and 7B include examples of a visual indicator limited to a particular type of information, the scope of the present invention also includes other embodiments of visual indicators that communicate other types of information. In addition, the visual indicators may be configured to communicate multiple types of information. For instance, the examples shown in FIGS. 7A and 7B may include a visual indicator 155 having a plurality of stripes, where each stripe has a unique color that identifies a particular status or property related to the document. For instance, in the example involving the legal opinion, the visual indicator 155 may comprise a yellow and red stripe displayed with the text of the document, where each color respectively communicates that the opinion has been withdrawn and that it is unpublished.

In one embodiment, the visual indicator 155 may be configured to extend throughout the length of the document. Thus, if a user scrolls from the top of the document to the bottom of the document, the visual indicator 155 is continuously displayed to the user. Although this illustrative example shows one continuous image, having a particular color or shade, the visual indicator 155 may be broken into several sections or configured such that it does not extend through the length of the document. However, the visual indicator 155 should be configured such that it is conspicuously displayed on the interface near all text portions of the document.

In yet another embodiment, the visual indicator 155 may be configured to be focused in certain sections of the document that are of particular interest to the user. For instance, the visual indicator 155 may be one or two text or icon images that are configured in the document such that they are displayed near the keywords that were provided by the user. For instance, in the embodiment shown in FIG. 7B, the visual indicator may be an icon that is positioned near the word “state.”

As described above, the visual indicator 155 may be an image that is configured to be displayed through the entire length of the document. Alternatively, the visual indicator may be an image that is selectively displayed near text of the document that may be of interest to a user. In other embodiments, the visual indicator may be a number of text characters positioned thought the body of the displayed document. In yet another embodiment, the document may be configured with an attribute that causes a computing device to generate an audible signal to communicate a document's contextual information. Accordingly, the visual indicator may be any image, text or signal that communicates the document's contextual information and serves to draw the user's attention.

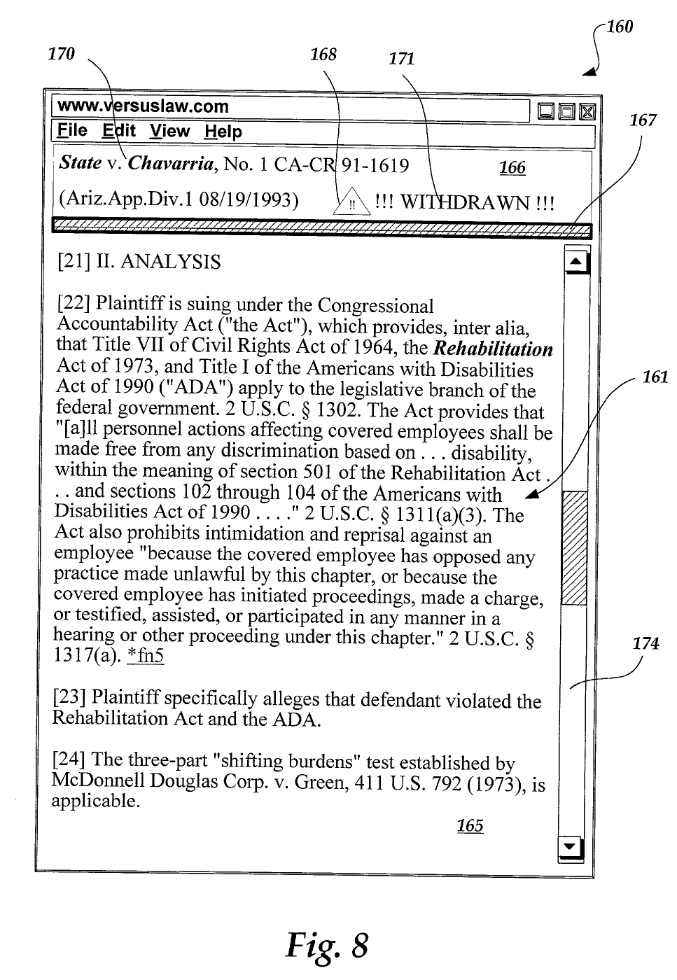

Referring now to FIG. 8, aspects of another embodiment of the present invention will be described. FIG. 8 illustrates one example of a user interface 160 that displays an attribute-enhanced document 161 having contextual information 170 and 171 associated with the contents of the document 161. In this embodiment, the document 161 is displayed on a user interface 160 having two image groups 165 and 166. As shown in FIG. 8, one image group 166 is configured to display the contents of the document 161. The illustrated example involves a known window configuration that allows a user to control the display of the document 161 by the use of a scroll bar 174. The other image group 165 is configured to continuously display contextual information 170 and 171 related to the contents of the document 161, regardless of position of the scroll bar 174 of the interface 160. Optionally, the communication of the contextual information may also involve the display of an image 168.

The illustrated example of FIG. 8 shows one embodiment of the present invention that utilizes a markup language for displaying a document on a Web browser application. In such an embodiment, the document may be configured with a known markup language feature known as “frames.” In such an embodiment, the two image groups 165 and 166 may be separated by a frame element 167. As can be appreciated by one of ordinary skill in the art, an embodiment involving image groups may comprise any number of image groups that may be displayed in one window, separate windows, or even separate software applications. In addition, although this illustrated example utilizes a markup language, such image groups may be configured by any known programming language for configuring a graphical user interface.

As can be appreciated by one of ordinary skill in the art, the above-described embodiments may be implemented by any known programming or document formatting languages. Accordingly, any suitable software application computer capable of displaying documents may be used to implement the embodiments of the present invention. In addition, the visual indicator, in accordance with the present invention, may be imbedded in an existing document by the use of any document formatting code. For instance, the attribute-enhanced document of the present invention may be configured with any document format data, such as XML, HTML, DHTML, or the like. Alternatively, the attribute-enhanced document may be configured into a variety of formats, such as ASCII, PDF, or the like. In an embodiment involving DHTML, a script, or other like programming language, the visual indicator may be a mobile image that moves with the viewable sections of the document to continually communicate the document's contextual information.

The embodiments described above illustrate an example of a legal document that is retrieved from a document server 125, which may be the result of a database query sent from a client computer 120. Although this example illustrates a legal document, various aspects of the present invention described herein may apply to any type of document or contextual information, regardless of the content, format, or contextual information associated with the document. Similarly, various aspects of the present invention may also apply to other systems that do not include a client-server configuration, such as one including a stand-alone computing device.

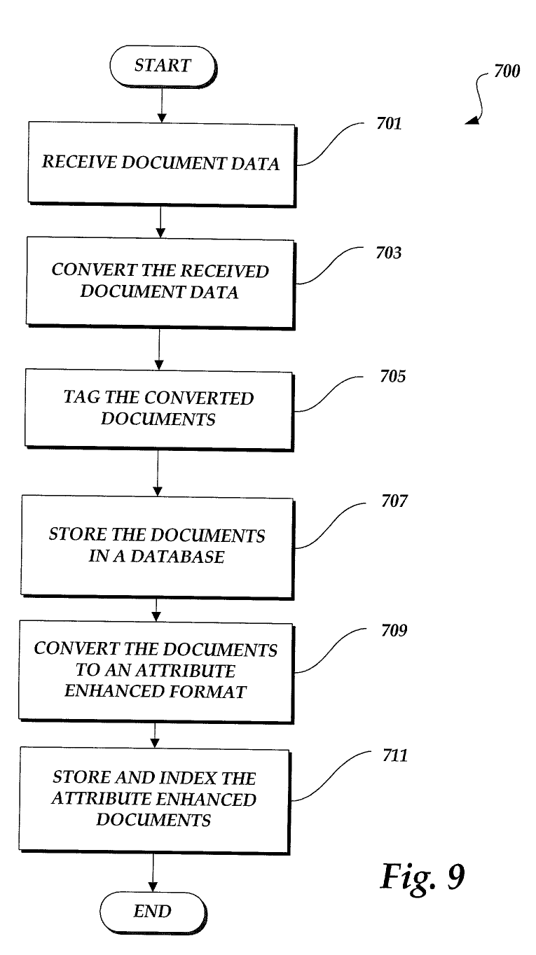

Referring now to FIG. 9, in conjunction with the system illustrated in FIGS. 3-5, an illustrative routine 700 for generating attribute-enhanced documents formed in accordance with the present invention is shown and described. The routine 700 begins at block 701 where a computing device, such as the process server 130 or document server 125, receives document data from a number of resources. For illustrative purposes, document data can include the contents of a document or any other related data. As can be appreciated by one of ordinary skill in the art, a server may receive document data by the use of a number of mediums, including a floppy disk, CD-ROM, optical recording device, network interface, or the like. As can be appreciated by one knowledgeable in the legal field, one example of the process of block 701 may involve the receipt of a number of legal documents from a number of publishers or information service providers. As can be appreciated by one of ordinary skill in the art, the received documents may be in any format, such as HTML, ASCII, PDF, or the like. Since the receipt of the documents may be from a number of different resources, a document conversion process may be necessary.

Next, as shown in block 703, the server then converts the received documents to a uniform format. In one embodiment of this process, the received documents may be converted into an ASCII text format. As can be appreciated by one of ordinary skill in the art, a number of known document software applications may be used to convert different document formats into one standard text format.

After the received documents are converted into a uniform format, the process then continues to block 705, where the documents are then tagged with attributes that communicate contextual information associated with the document or the contents of the document. In one example of this embodiment involving legal documents, specific text tags may be entered in the text documents to indicate the status of an opinion or legal memorandum. For instance, a “[U]” may be inserted into one or more sections of a document that contains an opinion that is unpublished, or a “[W]” may be inserted into the document when the case is withdrawn. As can be appreciated by one of ordinary skill in the art, the processing of block 705 may be conducted by a manual process involving a number of individuals reviewing the documents and inserting appropriate tags—or the process may be implemented by an automated system.

After the documents have been tagged in block 705, the routine 700 then continues to block 707 where the server stores the tagged documents in a database. This part of the routine 700 may involve a number of known database applications, such as Microsoft SQL®, for implementation. Optionally, this part of the routine 700 may also involve the storage of contextual information related to each document. In an example related to legal documents, this part of the routine 700 may involve the storage of contextual information, such as a case docket number, case title, or case cite. In this embodiment, the relevant contextual information is stored in the database with the contents of the document. Alternatively, the each document may be stored in an electronic file system that is accessible by a database or Web-based application.

Next, the routine 700 continues at block 709 where the stored documents are converted to an attribute-enhanced format. In accordance with the present invention, the attribute-enhanced documents created in this part of the routine 700 are configured in a manner similar to the documents described above, with respect to FIGS. 7A, 7B, and 8. Accordingly, the process of block 709 converts the documents processed in block 707 so that they include an attribute or format that communicates the document's contextual information. In one embodiment, the documents may be converted into an HTML format that includes at least one visual indicator that communicates the document's contextual information. As described above, this conversion process may involve any document formatting language.

Once the attribute-enhanced documents have been created, the routine 700 continues to block 711 where the attribute-enhanced documents are stored and indexed in a computer, such as the document server 125, capable of serving the documents to a number of clients 120. Accordingly, depending on the system architecture, the process of block 711 may involve the transfer of the attribute-enhanced documents from a process server 130 to a document server 125.

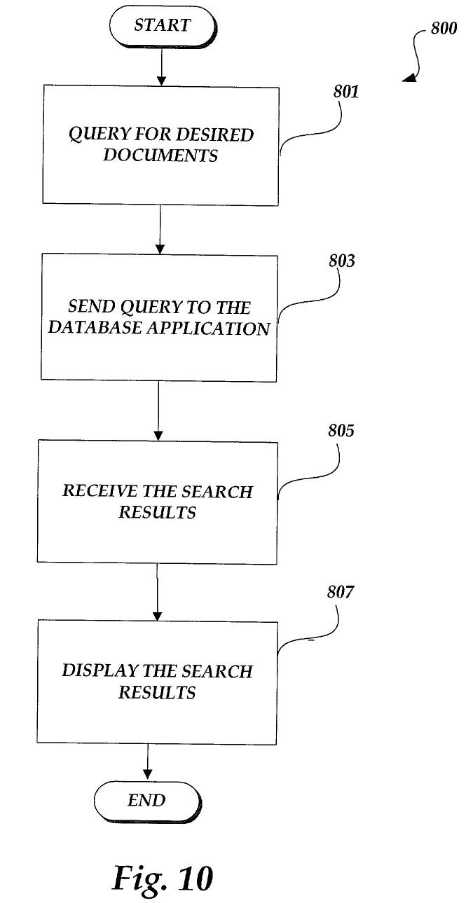

Referring now to FIG. 10, in conjunction with the system illustrated in FIGS. 3-5, an illustrative routine 800 for displaying attribute-enhanced documents formed in accordance with the present invention is shown and described. The routine 800 begins at block 801, where a computing device, such as a client computer 120, generates a query for one or more desired documents. As can be appreciated by one of ordinary skill in the art, the query generated by the client computer 120, may be conformed to accommodate any known database or Web-based text search.

Next, at block 803, the client computer 120 sends the query to the database application, which may be stored on a server, such as the document server 125. Once the query is received by the document server 125, the query is then processed in the database application, thereby producing a search result in the form of one or more attribute-enhanced documents. The attribute-enhanced documents are then received by the client computer 120, as indicated in block 805. The routine 800 then proceeds to block 807, where the attribute-enhanced documents are displayed on a user interface on a computing device, such as the client computer 120. Accordingly, when configured in a manner similar to the embodiments shown in FIGS. 7A, 7B and 8, the attribute-enhanced document display a visual indicator that communicates the contextual information related to the document.

As described above, one embodiment of the present invention involves a method where received document data is converted into a number of attribute-enhanced documents. Although one embodiment of the invention systematically generates attribute-enhanced documents while the document data is received by the external sources, the present invention may integrate the generation of attribute-enhanced documents in other routines. For instance, a server may be configured to dynamically generate the attribute-enhanced document responsive to a database query, as described above with respect to block 803 of FIG. 10. As a result, this embodiment may also include a step where the server receives additional information from the user so that the server configures a custom attribute-enhanced document.

While several embodiments of the invention have been illustrated and described, it will be appreciated that various changes can be made therein without departing from the scope of the invention. Similarly, any process steps described herein might be interchangeable with other steps in order to achieve the same result. In addition, the illustrative examples described above are not intended to be exhaustive or to limit the invention to the precise forms disclosed. For instance, the method of the present invention may be implemented in a stand-alone software application, client-server application, Web-based application, or any other application that involves the display of documents. The method and system of the present invention also applies to any document format or computer language used to format or configure documents.

The embodiments of the invention in which an exclusive property or privilege is claimed are defined as follows:

1. A method of generating a document, wherein the method comprises:
obtaining document data and contextual information related to the document data; and
combining the document data with the contextual information to generate a document, wherein a format of the document allows an interface to continuously display the contextual information with the document data.

2. The method of claim 1, wherein the contextual information provides an indication that the content of the document involves a statute.

3. The method of claim 1, wherein the contextual information provides an indication that the content of the document involves a government-related regulation.

4. The method of claim 1, wherein the contextual information provides an indication that the content of the document involves a withdrawn legal opinion.

5. The method of claim 1, wherein the contextual information provides an indication that the content of the document involves an unpublished legal opinion.

6. The method of claim 1, wherein the display of the contextual information comprises the display of an image configured to be continuously displayed throughout the length of the document.

7. The method of claim 1, wherein the display of the contextual information comprises the display of an image configured to be displayed with selected portions of the document.

8. The method of claim 1, wherein the display of the contextual information comprises the display of at least one image, wherein the image is color-coded with a plurality of preselected colors, wherein each color of the plurality of preselected colors identifies a specific characteristic related to the document.

9. The method of claim 1, wherein the display of the contextual information comprises the display of a text message communicating a status associated with the document.

10. The method of claim 1, further comprising, combining the contextual information and the document data with document format data for allowing the document to concurrently display the document data and the contextual information, wherein interface displays less than all of the document.

11. A method of displaying document data and contextual information associated with the document data, wherein the method comprises:
obtaining document data and contextual information related to the document data; and
displaying the contextual information with the document data on an interface, wherein the interface displays less than all of the document data, and wherein the display of the contextual information allows the interface to continuously display the contextual information.

12. The method of claim 111, further comprising:
receiving an indication from a user to preview at least one document having document data; and
in response to receiving the indication, transmitting document data and contextual information related to the document data from a server computer to a client computer, wherein the transmission of the data involves a formatted document configured to display the contextual information with the document data on an interface, wherein the formatted document allows the interface to continuously display the contextual information with the document data even if the interface displays less than all of the document data.

13. A system for displaying a document, comprising:
a memory unit storing document data and contextual information related to the document data; and
a display unit for displaying the contextual information with the document data on the display unit, wherein the format of the document allows the display unit to display the contextual information with the document data, even if the display unit limits the display of the document data to a portion of the document data.

14. A system for displaying a document, comprising:
means for receiving document data and contextual information related to the document data; and
a display means for displaying the contextual information with the document data on the display means, wherein the format of the document allows the display means to display the contextual information with the document data even if the display means limits the display of the document data to a portion of the document data.

15. A system for generating a document, comprising:
means for receiving document data and contextual information related to the document data;
a memory unit for storing the received document data and contextual information; and
a computing unit for combining the document data with display configuration data for allowing the document to concurrently display the document data and the contextual information on a display device, wherein the display configuration data is configured to allow the document to continuously display the contextual information on an interface even if the display of the document data is limited to displaying a portion of the document data.

16. A method of displaying a document and contextual information associated with the document, wherein the method comprises:
displaying at least one document in a first image group of a display; and
displaying a visual indicator for communicating the contextual information on said display in a second image group, concurrently with said first image group, wherein the visual indicator continuously displays the contextual information even if the document displayed in the first image group is limited to the display of a section of the document.

17. The method of claim 16, wherein the contextual information provides an indication that the content of the document involves a statute.

18. The method of claim 16, wherein the contextual information provides an indication that the content of the document involves a government related regulation.

19. The method of claim 16, wherein the contextual information provides an indication that the content of the document involves a withdrawn legal opinion.

20. The method of claim 16, wherein the contextual information provides an indication that the content of the document involves an unpublished legal opinion.

21. The method of claim 16, wherein the display of the contextual information comprises the display of at least one image, wherein the image is color-coded with a plurality of preselected colors, wherein each color of the plurality of preselected colors identifies a specific characteristic associated with the document.

22. The method of claim 16, wherein the display of the contextual information comprises the display of a text message communicating a characteristic associated with the document.
